(19) United States
(12) Patent Application Publication
(10) Pub. No.: US 2008/0181192 A1
(43) Pub. Date: Jul. 31, 2008

(54) RADIO COMMUNICATION APPARATUS AND RADIO COMMUNICATION METHOD

(75) Inventors: Toshihisa Nabetani, Kawasaki-Shi (JP); Tomoko Adachi, Urayasu-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/855,604

(22) Filed: Sep. 14, 2007

(30) Foreign Application Priority Data
Jan. 30, 2007 (JP) 2007-019259

(51) Int. Cl. H04J 3/00

(52) U.S. Cl. 370/345

(57) ABSTRACT

There is provided with a radio communication method including: managing carrier sensing states of any one of two first channels having identical bandwidths and a second channel including both bands of the two first channels; determining whether to transmit transmission data using the first channel or the second channel; attempting to acquire a transmission right using the second channel based on the carrier sensing state of the second channel when the transmission data is determined to be transmitted using the second channel; and performing control such that the transmission data is transmitted using any one of the first channels when the time during which the attempt to acquire the transmission right using the second channel is made exceeds a time threshold set in advance.

### CROSS-REFERENCE TO RELATED APPLICATIONS

This application is based upon and claims the benefit of priority from the prior Japanese Patent Applications No. 2007-19259 filed on Jan. 30, 2007, the entire contents of which are incorporated herein by reference.

### BACKGROUND OF THE INVENTION

1. Field of the Invention

The present invention relates to a technical field of radio communication, and more particularly, to a radio communication apparatus and a radio communication method which exercises media access control based on a carrier sensing state.

2. Related Art

Media access control (MAC) is control whereby, when a plurality of communication apparatuses carry out communications by sharing an identical medium, each communication apparatus determines how to use the medium to transmit communication data.

In radio communication, there are several media access control methods capable of efficiently transmitting communication data through a plurality of communication apparatuses, and IEEE802.11, which is a representative standard for a wireless LAN (Local Area Network), adopts a CSMA/CA (Carrier Sense Multiple Access with Collision Avoidance) scheme as a media access control method whereby transmission is performed after confirming through carrier sensing that a medium continues to be unoccupied (idle) for a certain time or more to avoid data collision. A continuous wait time in such a case is a minimum time plus a wait time of a random length and this is a scheme that can prevent a plurality of communication apparatuses from carrying out transmissions concurrently a certain time after an immediately preceding communication (see “Wireless LAN Medium Access Control (MAC) and Physical Layer (PHY) specifications,” IEEE Std, 802.11, August 1999).

On the other hand, IEEE802.11n standard, which is a standard geared toward further speed enhancement in a wireless LAN proposes a method of increasing frequency bands, which are media, as one of approaches to communication speed enhancement. An existing IEEE802.11 wireless LAN system (IEEE802.11a/b/g) carries out communication in a 20 MHz frequency band per channel, but IEEE802.11n extends its channel to a neighboring channel and can realize a communication in a 40 MHz frequency band corresponding to two channels including the neighboring channel.

Even in the case of carrying out a 40 MHz transmission, the IEEE802.11n system is preferably based on a CSMA/CA scheme which is basically consistent with the existing standard in order to maintain backward compatibility with the existing wireless LAN system and realize coexistence therewith. Therefore, when carrying out a 40 MHz transmission, as in the case of the CSMA/CA scheme based on carrier sensing in a conventional 20 MHz band, carrier sensing in a 40 MHz band corresponding to 2 channels is carried out and a 40 MHz transmission is carried out after confirming that the 40 MHz band continues to be idle for a certain time or more.

When transmission at 40 MHz is carried out according to IEEE802.11n, it is necessary to extend the CSMA/CA scheme through carrier sensing in an existing 20 MHz channel band, realize a CSMA/CA scheme through carrier sensing in a 40 MHz channel band and acquire a transmission right at 40 MHz. Therefore, during the 40 MHz transmission, since carrier sensing is carried out on two channels; the existing 20 MHz channel (hereinafter referred to as an “own channel”) and the neighboring 20 MHz channel to be extended (hereinafter referred to as an “extended channel”), it is a condition for acquiring the transmission right as shown in FIG. 10 that the media are simultaneously idle for a certain time or more on both channels.

Therefore, in the case of the 40 MHz transmission compared to the 20 MHz transmission, the time until the transmission right is acquired through carrier sensing, that is, the time until it is possible to confirm that the media continue to be idle for a certain time or more may be extended. For example, even when the own channel is idle for a certain time or more during the 40 MHz transmission, the transmission right cannot be acquired unless the extended channel side is idle (that is, when it is “busy”) and moreover, it may be well imaginable conversely, that the own channel becomes busy at a time point at which the extended channel side becomes idle.

In this way, compared to the 20 MHz transmission, the 40 MHz transmission using carrier sensing in the 40 MHz channel band can shorten the transmission time of a transmission frame itself through an improvement in the physical transmission speed, but since the time until the transmission right is acquired is extended and as a result a more time is required until the transmission frame is completed, leading conversely to throughput degradation.

### SUMMARY OF THE INVENTION

According to an aspect of the present invention, there is provided with a radio communication apparatus comprising:

a first communication unit configured to carry out radio communication using any one of two first channels having identical bandwidths;

a second communication unit configured to carry out radio communication using a second channel including both bands of the two first channels;

a carrier sensing state manager configured to manage carrier sensing states of at least one of the first channels and the second channel;

a determining unit configured to determine whether to transmit transmission data using the first channel or the second channel;

a transmission right acquiring unit configured to attempt to acquire a transmission right using the second channel based on the carrier sensing state of the second channel when the transmission data is determined to be transmitted using the second channel; and

a controller configured to perform control such that the transmission data is transmitted using any one of the first channels when a time during which an attempt to acquire the transmission right using the second channel is made exceeds a time threshold set in advance.

According to an aspect of the present invention, there is provided with a radio communication method comprising:

managing carrier sensing states of any one of two first channels having identical bandwidths and a second channel including both bands of the two first channels;

determining whether to transmit transmission data using the first channel or the second channel;

attempting to acquire a transmission right using the second channel based on the carrier sensing state of the second channel when the transmission data is determined to be transmitted using the second channel; and

performing control such that the transmission data is transmitted using any one of the first channels when the time during which the attempt to acquire the transmission right using the second channel is made exceeds a time threshold set in advance.

### BRIEF DESCRIPTION OF THE DRAWINGS

FIG. 1 is a block diagram showing a configuration example of a radio communication apparatus according to a first embodiment of the present invention;

FIG. 2 illustrates a configuration example of a network including the radio communication apparatus according to the first embodiment of the present invention;

FIG. 3 illustrates a first channel with a first bandwidth and a second channel with a second bandwidth according to the first embodiment of the present invention;

FIG. 4 is an operation processing flow chart when using a radio communication method according to the first embodiment of the invention;

FIG. 5 illustrates an operation example according to the first embodiment of the present invention;

FIG. 6 is an operation processing flow chart when using a radio communication method according to a second embodiment of the present invention;

FIG. 7 illustrates an operation example according to the second embodiment of the present invention;

FIG. 8 illustrates another operation example according to the second embodiment of the present invention;

FIG. 9 illustrates a further operation example according to the second embodiment of the present invention; and

FIG. 10 is an example during transmission on a 40 MHz channel based on IEEE802.11n.

### DETAILED DESCRIPTION OF THE INVENTION

Hereafter, embodiments of the present invention will be explained more specifically with reference to the attached drawings.

### First Embodiment

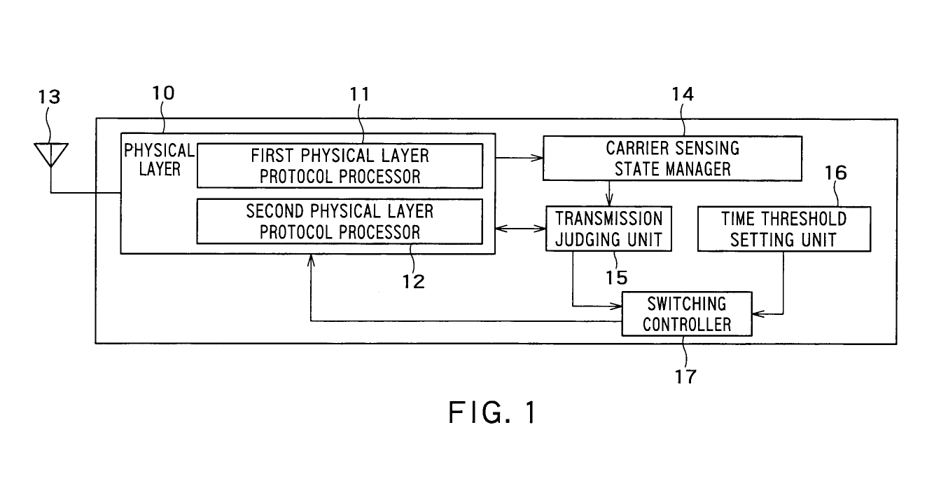

FIG. 1 is a block diagram showing a configuration example of a radio communication apparatus according to a first embodiment of the present invention.

This radio communication apparatus is constructed of a physical layer 10, an antenna 13, a carrier sensing state manager 14, a transmission judging unit (determining unit, transmission right acquiring unit) 15, a time threshold setting unit 16 and a switching controller (controller) 17. The physical layer 10 supports two types of physical layer protocols having different frequency bands of channels to be used. That is, the physical layer 10 has a first physical layer protocol processor 11 which performs physical layer protocol processing for carrying out radio communication using a first channel having a first frequency bandwidth and a second physical layer protocol processor 12 which performs physical layer protocol processing for carrying out radio communication using a second channel having a bandwidth which is wider than the first frequency bandwidth and which overlaps with the first frequency bandwidth. The first physical layer protocol processor 11 and the second physical layer protocol processor 12 often share their circuits or the like and are not necessarily independent of each other.

Suppose the first channel which has the first frequency bandwidth used by the first physical layer protocol processor 11 is, for example, 20 MHz and the first physical layer protocol processor 11 includes a physical layer protocol defined in, for example, at least any one of IEEE802.11a/b/g. In that case, the antenna 13 may carry out a MIMO (Multi Input Multi Output) transmission using a plurality of antenna elements.

Suppose the second channel which has the second frequency bandwidth used by the second physical layer protocol processor 12 is, for example, 40 MHz and the first channel exists inside the band of the second channel. The second physical layer protocol processor 12 may also carry out a MIMO transmission using a plurality of antenna elements.

The carrier sensing state manager 14 manages a state of a channel (idle state or busy state) using carrier sensing information obtained from the physical layer 10. That is, the carrier sensing state manager 14 manages the states of at least one or more first channels having the first frequency bandwidth and one or more second channels having the second frequency bandwidth.

When transmitting data (transmission data) from a higher layer using the second channel having the second frequency bandwidth, the transmission judging unit 15 judges whether or not the transmission right has been successfully acquired on the second channel. That is, the transmission judging unit 15 judges based on the carrier sensing information whether or not transmission on the second channel has been made possible. When the transmission judging unit 15 judges that transmission on the second channel is possible, the second physical layer protocol processor 12 of the physical layer 10 carries out a data transmission using the second channel.

The time threshold setting unit 16 sets a time threshold used for switching control at the switching controller 17.

The switching controller 17 performs control over switching from the transmission processing using the second channel to the transmission processing using the first channel using the time threshold set by the time threshold setting unit 16. When, for example, the transmission right for the second channel has not been successfully acquired within the time threshold set by the time threshold setting unit 16, the switching controller 17 performs control over switching to the transmission processing using the first channel. When switching control is performed, the first physical layer protocol processor 11 of the physical layer 10 carries out a data transmission using the first channel.

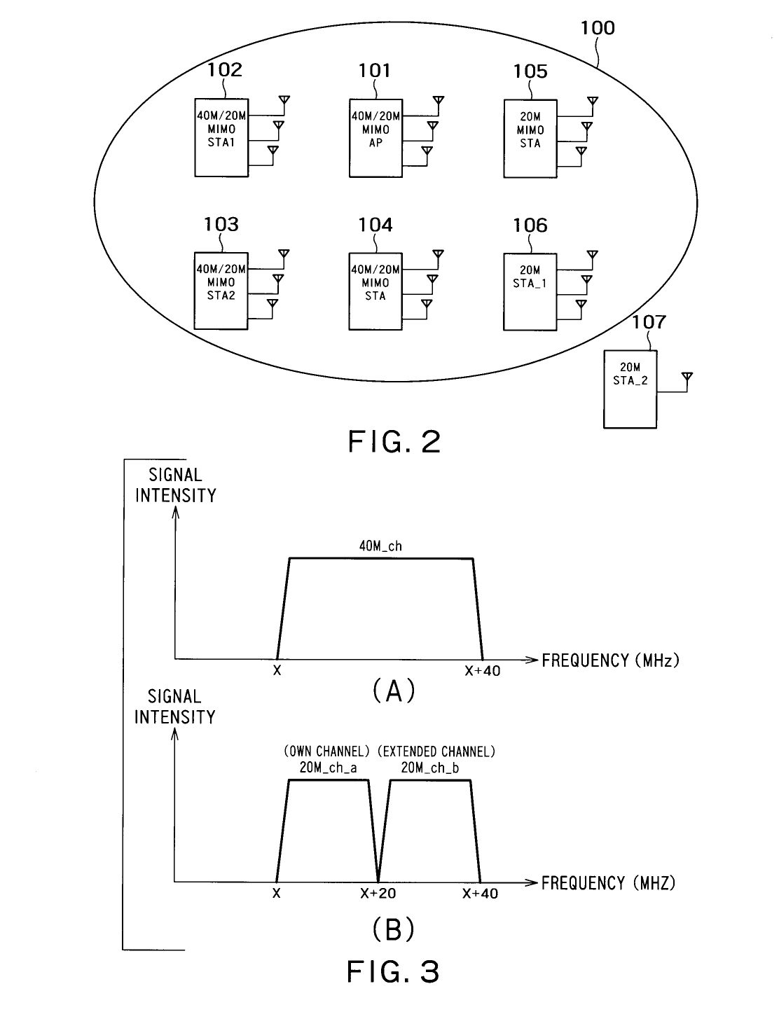

FIG. 2 shows a configuration example of a network 100 including the radio communication apparatus in FIG. 1. A base station 101 in the network 100 is an access point capable of MIMO transmission/reception or SISO (Single Input Single Output) transmission/reception using a 40 MHz channel and a 20 MHz channel. Terminals 102 to 106 establish an association with the base station 101. Here, the terminals 102 and 103 are capable of MIMO transmission/reception or SISO transmission/reception using a 40 MHz channel and a 20 MHz channel, the terminal 104 is capable of MIMO transmission/reception using 40 MHz channel and SISO transmission/reception using 20 MHz, the terminal 105 is capable of MIMO transmission/reception or SISO transmission/reception using only a 20 MHz channel and the terminal 106 is a terminal capable of only SISO transmission/reception using a 20 MHz channel. Suppose another terminal 107 belongs to a network other than the network 100.

The network 100 in FIG. 2 uses, as communication channels, a 20 MHz channel 20M_ch_a using a frequency band of X MHz to (X+20) MHz shown in FIG. 3(B) and a 40 MHz channel 40M_ch using a frequency band of X MHz to (X+40) MHz shown in FIG. 3(A). Therefore, the frequency band of X MHz to (X+20) MHz is used redundantly between the 20 MHz channel and the 40 MHz channel. Another 20 MHz channel 20M_ch_b using the frequency band of (X+20) MHz to (X+40) MHz shown in FIG. 3(B) is not used in the network 100 in FIG. 2, but may be used in another network (for example, the network to which the terminal 107 in FIG. 2 belongs). Therefore, it is also imaginable that when another network using 20M_ch_b is located adjacent to (overlapping) the network 100, 20M_ch_b may also be used redundantly with 40 MHz channel 40M_ch using the frequency band of X MHz to (X+40) MHz. That is, in the network 100 of FIG. 2, 20M_ch_a corresponds to the own channel which carries out an existing 20 MHz channel transmission and 20M_ch_b corresponds to the extended channel adjacent to the own channel which is extended.

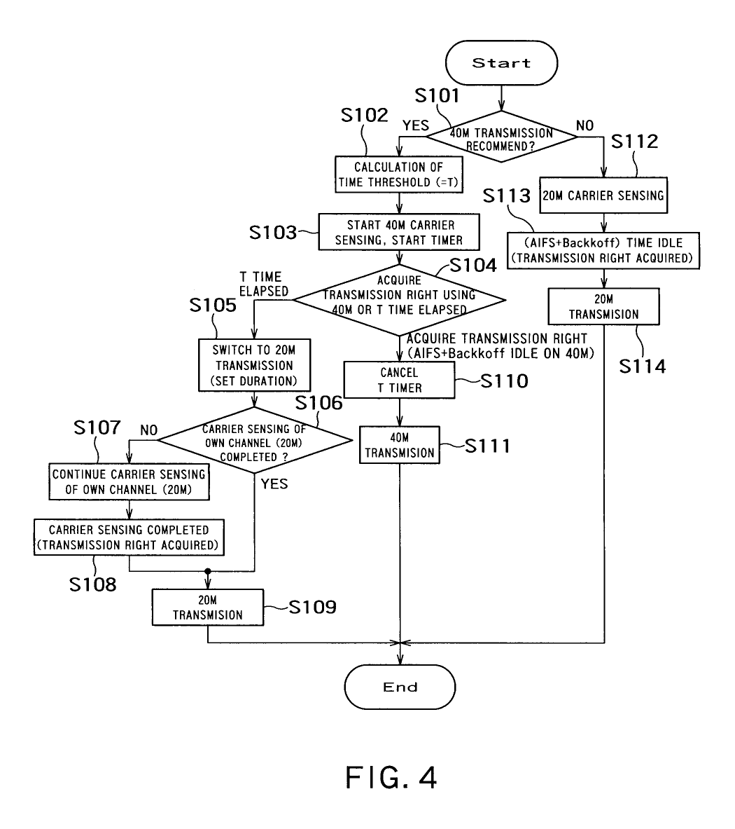

Next, the operation processing will be explained using the flow in FIG. 4. When data to be transmitted from a higher layer is generated, the radio communication apparatus shown in FIG. 1 determines whether or not to transmit the data using 20 MHz channel 20M_ch_a of the own channel or 40 MHz channel 40M_ch according to a certain judgment (S101) first. When the transmission data is judged to be transmitted using 40M_ch of the 40 MHz channel, processing from S102 onward will be carried out. Here, the above described judgment may be based on anything, and whether the data should be transmitted using the 20 MHz channel or the 40 MHz channel is selected according to, for example, a method whereby a channel bandwidth (20 MHz channel or 40 MHz channel) with which the destination terminal expects the data to be transmitted is reported and it is judged whether to transmit the data using the 20 MHz channel or the 40 MHz channel accordingly or a method whereby when the destination terminal can receive the data using the 40 MHz channel, transmission using the 40 MHz channel is always selected. When it is judged based on a certain judgment that transmission should be carried out using the 20 MHz channel, transmission processing is carried out based on carrier sensing on the 20 MHz channel 20M_ch_a (own channel) as in the case of conventional IEEE802.11 and transmission is carried out on 20M_ch_a using the first physical layer protocol processor 11, and therefore details will be omitted (S112 to S114).

When transmission using the 40 MHz channel is selected, the time threshold setting unit 16 sets a time threshold T to be used for a timer (S102). Details of the setting of the time threshold will be described later. Furthermore, concurrently therewith, the transmission judging unit 15 starts transmission right acquisition processing using 40M_ch and also starts the timer at the same time (S103). Here, the transmission judging unit 15 makes a judgment as to whether or not the transmission right on 40M_ch has been successfully acquired, that is, a judgment as to whether or not transmission on 40M_ch has been made possible by implementing the CSMA/CA scheme of IEEE802.11 using the 40 MHz channel band. That is, transmission using 40M_ch is judged to be possible when the carrier sensing state of 40 MHz channel 40M_ch under the management of the carrier sensing state manager 14 has continued to be idle for a certain time (specific period) or more specifically AIFS (Arbitration Inter Frame Space) time+random backoff time. The carrier sensing state of 40M_ch used here under the management of the carrier sensing state manager 14 may be subjected to carrier sensing and managed as whole 40M_ch as is or the carrier sensing states of two 20 MHz channels 20M_ch_a and 20M_ch_b may be combined and managed assuming this as a 40M_ch carrier sensing state. When two 20 MHz channels are combined and assumed as a carrier sensing state of 40 MHz channel, if the respective 20 MHz channels are idle, the carrier sensing state of the 40 MHz channel may be assumed to be idle.

When the transmission judging unit 15 judges within a time threshold T that the carrier sensing state on 40M_ch has continued to be idle for the AIFS time+random backoff time and that transmission using 40M_ch is possible (that is, the transmission right on 40M_ch has been successfully acquired within the time threshold T), the transmission judging unit 15 cancels the timer (S110), sends an instruction for carrying out transmission on 40M_ch to the second physical layer protocol processor 12 and carries out transmission on 40M_ch (S111).

On the other hand, when the timer which has been started at the start of the transmission right acquisition processing has passed the time threshold T before the transmission judging unit 15 judges that transmission on 40M_ch is possible (that is, when the transmission right on 40M_ch has not been successfully acquired even when the time threshold T has elapsed), the switching controller 17 performs control over switching from transmission on the 40 M channel to transmission on 20M_ch_a which is the 20 M channel (S105). In such a case, when a value calculated as a case where the 40 M channel is used is already set in a “Duration” field which indicates the time related to data transmission included in the MAC header, a calculated value in a case where the 20 M channel is used is set in the Duration field.

When the switching controller 17 performs control over switching from the 40 M channel transmission to the 20 M channel transmission, it is checked at that time point whether or not the carrier sensing state of 20M_ch_a which is the channel for transmission after switching has continued to be idle for the AIFS time+random backoff time (S106). Here, the above described check is possible when control over switching from the 40 M channel transmission to the 20 M channel transmission is performed by managing the random backoff value when transmitting data on 40M_ch and the random backoff value when transmitting data on 20M_ch_a separately. Furthermore, even when the random backoff values are not managed separately, it is also possible to determine the random backoff value of 20M_ch_a for every check and carry out a check based on the value (temporally track back from the check time point and carry out a check as to whether or not the state has continued to be idle for the AIFS time+random backoff time).

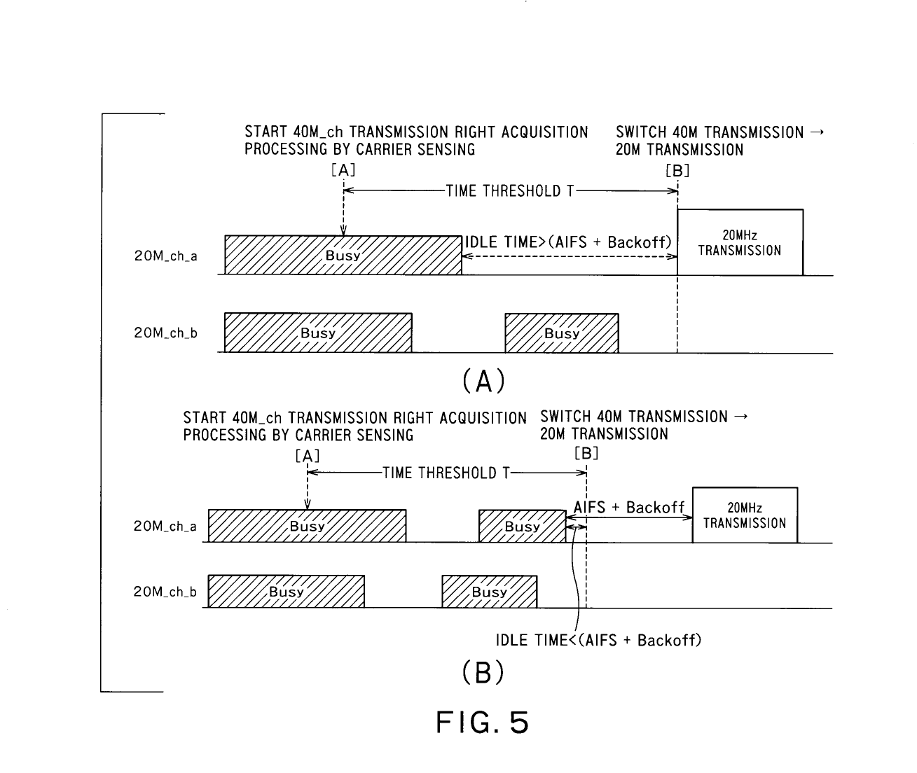

In S106, if the carrier sensing state of 20M_ch_a has already continued to be idle for the AIFS time+random backoff time or more, it is judged at that time point that the transmission right on 20M_ch_a has been successfully acquired, an instruction is sent to the first physical layer protocol processor 12 and transmission on 20M_ch_a is carried out (S109). An operation example in such a case is shown in FIG. 5(A).

On the other hand, in S106, if the carrier sensing state of 20M_ch_a has not continued to be idle for the AIFS time+random backoff time or more, the system continues to wait until the state on 20M_ch_a continues to be idle for the AIFS time+random backoff time (S107), at the time point at which the state has continued to be idle for the AIFS time+random backoff time, it is judged that the transmission right on 20M_ch_a has been successfully acquired (S108), an instruction is sent to the first physical layer protocol processor 11 and transmission on 20M_ch_a is carried out (S109). An operation example in such a case is shown in FIG. 5(B).

As described above, even when transmission on the 40 M channel is determined to be carried out based on a certain judgment, the first embodiment of the present invention sets a time threshold T and switches over to transmission on the 20 M channel when it is judged based on the carrier sensing state that it takes time to acquire the transmission right on the 40 M channel, and can thereby prevent throughput degradation. Furthermore, in such a case, if the 20 M channel has continued to be idle for the AIFS time+random backoff time at the time point at which the channel is switched over to the 20 M channel, transmission on the 20 M channel is possible at that time point, and therefore no overhead due to switchover more than necessary is produced.

Here, the setting of the time threshold T for switchover from the 40 M channel to the 20 M channel becomes important to make the most of the effect by the 40 M channel transmission while preventing throughput degradation. Hereinafter, the policy for setting the time threshold T will be described.

According to the first embodiment of the present invention, since transmission on the 40 M channel is attempted at least until the time threshold T, the time within a range in which transmission on the 40 M channel can consequently improve throughput is set as the time threshold T. More specifically, assuming the difference between the data transmission duration (or a corresponding Ack duration) required when transmitting the data whose transmission is requested on the 40 M channel and the data transmission duration (or a corresponding Ack duration) required when transmitting the data whose transmission is requested on the 20 M channel as the transmission time that can be shortened by transmitting the data on the 40 M channel compared to the case of transmitting the data on the 20 M channel, this transmission time that can be shortened by transmitting the data on the 40 M channel is set as the time threshold T. The transmission duration can be basically calculated based on the data length and the transmission rate.

In this way, when the transmission right is acquired using 40 M channel transmission within the time threshold T, the time required from the transmission right acquisition starting processing to the completion of the data transmission (or a corresponding Ack duration) is shorter than the case where data is transmitted on the 20 M channel, and therefore a better throughput can be obtained by transmitting data on the 40 M channel. On the other hand, in the case where the time required to acquire the transmission right using the 40 M channel transmission exceeds the time threshold T, the increase in the duration required to acquire the transmission right exceeds the reduction of transmission duration made possible by transmission using the 40 M channel. For this reason, the time (or a corresponding Ack duration) required from the transmission right acquisition starting processing to the completion of data transmission is extended consequently because of an attempt to transmit data on the 40 M channel. Therefore, when it takes the time threshold T or more to acquire the transmission right, the system judges that waiting further for transmission on the 40 M channel will conversely degrade the throughput compared to the 20 M channel transmission and switches the 40 M channel transmission over to the 20 M channel transmission. In this way, by attempting to transmit data using the 40 M channel until some effect of the 40 M channel transmission on a throughput improvement can be brought about and switching the 40 M channel transmission over to the 20 M channel transmission at a time point at which it is judged that the effect of the 40 M channel transmission on a throughput improvement cannot be obtained, it is possible to make the most of the effect using the 40 M channel transmission while preventing throughput degradation.

When the data to be transmitted is not of a best effort type data but of a real-time type data or the like, an allowable transmission delay time (Delay Bound) may be defined. In such a case, the transmission time that can be shortened using the 40 M channel transmission or the allowable transmission delay time, whichever is the shorter, may also be set as the time threshold T. For example, 1.5 ms is set as the time threshold T when the transmission time that can be shortened using the 40 M channel transmission is 1.5 ms and the allowable transmission delay time is 3 ms, while 3 ms is set as the time threshold T when the transmission time that can be shortened using the 40 M channel transmission is 5 ms and the allowable transmission delay time is 3 ms. Making such a setting allows control over switching from the 40 M channel to the 20 M channel with the allowable transmission delay time taken into consideration and thereby prevents transmission using the 40 M channel from being carried out to an extent exceeding the allowable transmission delay time.

Furthermore, the above described time of the time threshold T (the transmission time that can be shortened using the 40 M channel transmission or the allowable transmission delay time, whichever is the shorter) is merely a maximum time of a set value and the setting may also be made within a range assuming the maximum time as an upper limit as follows. For example, it is possible to consider a method whereby a value (T′×α) resulting from simply multiplying the maximum time T′ obtained by a fixed value parameter α (<1) is set as the time threshold T.

Furthermore, it is also possible to determine the value α (<1) by which the maximum time T′ obtained is multiplied such that α becomes a value which is variable according to a situation. Examples of the method of determining the variable value α (<1) in such a case include:

a method of determining α such that α increases proportionately as the amount of transmission time that can be shortened using the 40 M channel transmission increases (so as to attempt to carry out transmission using the 40 M channel as much as possible by extending the time for switching from the 40 M channel transmission to the 20 M channel transmission within a range that the throughput does not degrade as the amount of transmission time reduced using the 40 M channel transmission increases)

a method of determining α such that α increases proportionately as the allowable delay time of data to be transmitted increases (because the greater the amount of allowable delay time, the longer is the time until the allowable delay time is reached, it is possible to extend the time for switching from the 40 M channel transmission to the 20 M channel transmission within a range that the throughput does not degrade)

a method of determining α such that α decreases as the rate at which 20 M channel 20M_ch_a is busy within a certain period (busy rate) increases (because the higher the busy rate of 20M_ch_a, the lower is the probability that 20M_ch_a may continue to be idle for the AIFS time+random backoff time at the time point at which the 40 M channel is switched over to the 20 M channel and as a result, it also takes time to acquire the transmission right using 20M_ch_a).

The busy rate can be obtained by carrying out carrier sensing for a certain time, measuring the time during which the channel is busy and calculating the rate thereof. Furthermore, in the case of an IEEE802.11e-compliant wireless LAN, since the busy rate of the channel measured by an access point using a “Channel Utilization” field of a “QBSS Load” element in a “Beacon” frame is informed, it is also possible to ascertain the usage rate (busy rate) of the channel by extracting the value of a “Channel Utilization” field without measuring the value by itself. Furthermore, in the case of an IEEE802.11h-compliant wireless LAN, since the usage rate (busy rate) of the channel in a “CCA Busy Fraction” field can be ascertained through exchange of a “CCA Request” frame and a “CCA Response” frame, these frames can also be used. Furthermore, instead of the busy rate using carrier sensing, it is also possible to estimate the extent to which the channel is used for a certain period, for example, at an access point based on the number of terminals accommodated and “Traffic Stream (TS)” information set at each terminal or the like and use this as the busy rate.

### Second Embodiment

A second embodiment is different from the first embodiment in a judgment as to whether or not a transmission right on a second channel has been successfully acquired, that is, a judgment as to whether or not transmission on the second channel is possible.

The second embodiment makes a judgment as to whether or not a transmission judging unit 15 has successfully acquired a transmission right on 40M_ch, that is, a judgment as to whether or not transmission on 40M_ch is made not by implementing a CSMA/CA scheme of IEEE802.11 over the entire 40 MHz channel band but by carrying out carrier sensing using only 20M_ch_a and then taking the carrier sensing state on the 20M_ch_b side into consideration.

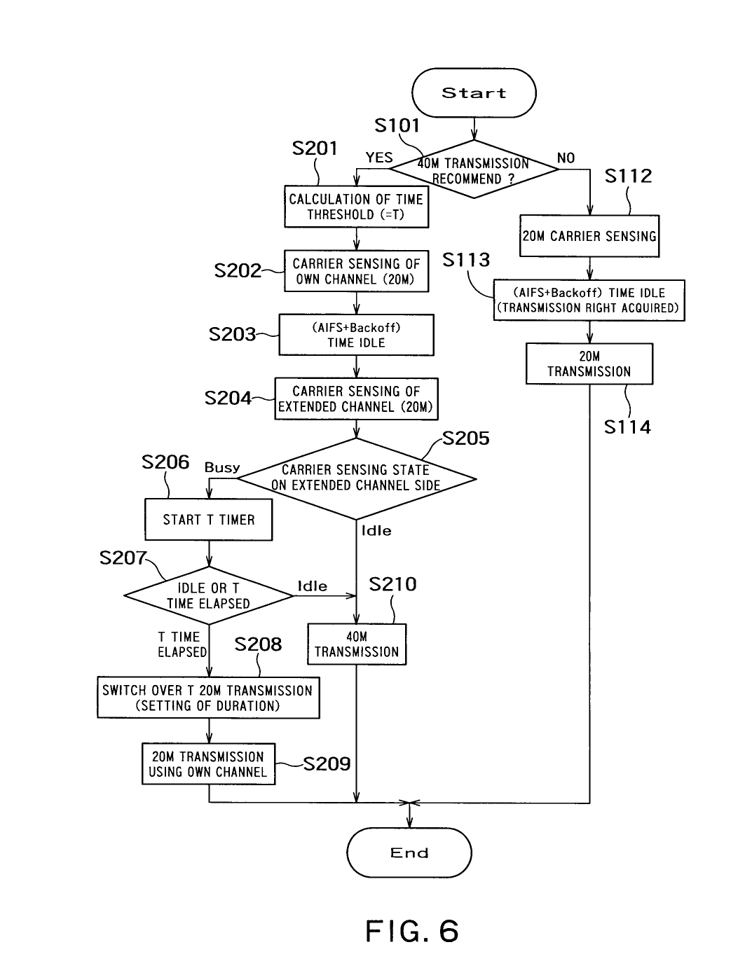

The operation processing according to the second embodiment will be explained using the flow chart in FIG. 6. Processes similar to those in the first embodiment are assigned the same reference numerals as those in FIG. 4.

First, in S101, when transmission using the 40 MHz channel is selected for some reason, a time threshold T used as a timer at a time threshold setting unit 16 is calculated (S201). The time threshold T is basically determined by a policy similar to that in the first embodiment. Furthermore, in order to judge whether or not the transmission right on 40 MHz has been successfully acquired concurrently therewith, the transmission judging unit 15 starts carrier sensing of 20 M channel 20M_ch_a (S202). At a time point at which the carrier sensing state of 20M_ch_a under the management of a carrier sensing state manager 14 has continued to be idle for a certain time (first specific period) or more specifically for an AIFS (Arbitration Inter Frame Space) time+random backoff time (S203), carrier sensing of 20M_ch_b which is another 20 M channel is carried out (S204).

Here, when the carrier sensing state of 20M_ch_b at that time point is idle, the transmission judging unit 15 judges that transmission on 40M_ch is possible, sends an instruction for carrying out transmission on 40M_ch to a second physical layer protocol processor 12 and carries out transmission on 40M_ch (S210). On the other hand, when the carrier sensing state of 20M_ch_b at that time point is busy, the transmission judging unit 15 starts the timer (S206) and waits until at least the carrier sensing state of 20 M_ch_b changes from busy to idle. When the carrier sensing state of at least 20 M_ch_b becomes idle before the timer started in S206 reaches the determined time threshold T, the transmission judging unit 15 judges that transmission on 40M_ch is possible, cancels the timer, sends an instruction for carrying out transmission on 40M_ch to the second physical layer protocol processor 12 and carries out transmission on 40M_ch (S210). On the other hand, when the timer started in S206 reaches the determined time threshold T before the state becomes idle, that is, when the state does not become idle even the time threshold T has elapsed, a switching controller 17 performs control over switching from the transmission on the 40 M channel to the transmission on 20M channel 20M_ch_a (S208). In such a case, when a value calculated as a case where the 40 M channel is used in a “Duration” field indicating a time related to data transmission included in a “MAC” header is already set, the transmission judging unit 15 sets the calculated value in the case where the 20 M channel is used in the Duration field, sends an instruction to the first physical layer protocol processor 12 to attempt to carry out transmission on 20M_ch_a (S209).

Here, in S205, while the system detects that the carrier sensing state of 20M_ch_b is busy and waits until the carrier sensing state of 20M_ch_b changes from busy to idle, it may also be detected that the carrier sensing state of 20M_ch_a becomes busy again. Therefore, when the system waits until the carrier sensing state of 20M_ch_b changes from busy to idle, it is more preferable to perform processing of waiting until the carrier sensing state changes from busy to idle as the entire 40 M channel including not only the carrier sensing state of 20M_ch_b but also the carrier sensing state of 20M_ch_a. That is, it is possible to judge that the state changes from busy to idle only based on the carrier sensing state of 20M_ch_b or judge that the carrier sensing state as entire 40M_ch including the carrier sensing state of 20M_ch_a changes from busy to idle. Making a judgment through carrier sensing of the whole 40 M channel including the carrier sensing state of 20M_ch_a can prevent packet collision because 20M_ch_a is also taken into consideration. However, there is correspondingly a high possibility that it will take more time until the state becomes idle.

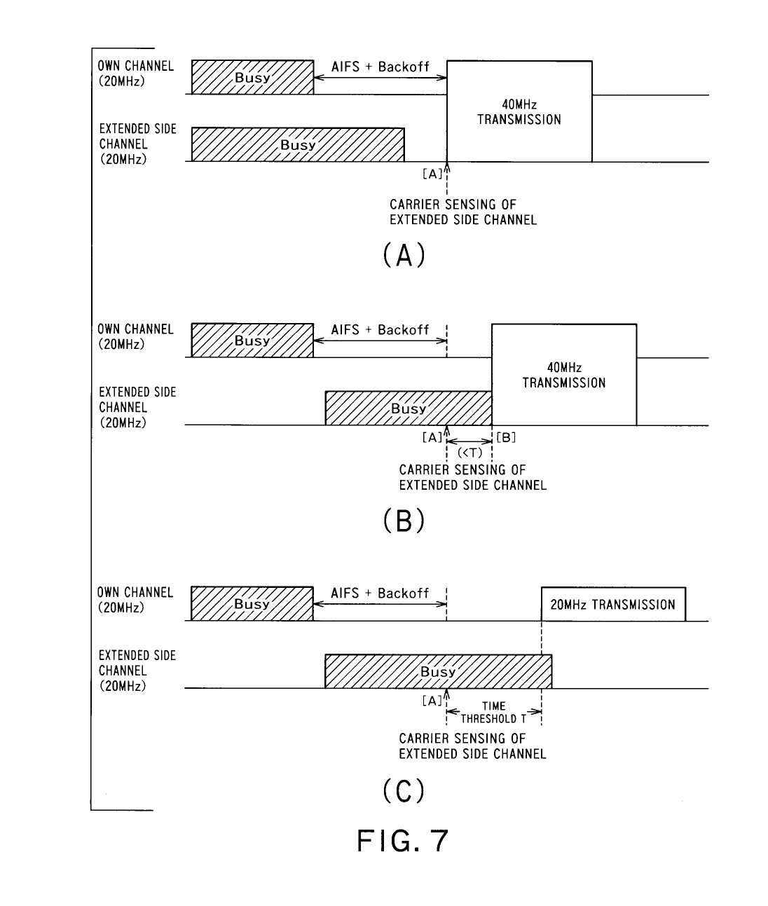

FIG. 7 shows an operation example according to the second embodiment.

FIG. 7(A) shows an example of a case where the carrier sensing state of 20M_ch_b is checked at a time point [A] at which the carrier sensing state on 20M_ch_a has continued to be idle for the AIFS time+random backoff time, the check result shows that the state is idle and therefore data is transmitted on the 40 M channel.

FIG. 7(B) shows an example of a case where the carrier sensing state of 20M_ch_b is checked at a time point [A] at which the carrier sensing state on 20M_ch_a has continued to be idle for the AIFS time+random backoff time, the check result shows that the state is busy and therefore the system waits until 20M_ch_b (or 40M_ch) changes from busy to idle and 40 M channel transmission is carried out at a time point [B] at which 20M_ch_b (or 40M_ch) becomes idle. Here, it is also possible to consider a method whereby at a time point at which the carrier sensing state manager 14 ascertains that 20M_ch_a becomes busy again while the system is waiting until the busy state is switched over to the idle state, the system resumes carrier sensing of only 20M_ch_a.

FIG. 7(C) shows an example of a case where the carrier sensing state of 20M_ch_b is checked at a time point [A] at which the carrier sensing state on 20M_ch_a has continued to be idle for the AIFS time+random backoff time, the check result shows the state is busy and the time threshold T has elapsed while the system is waiting until 20M_ch_b (or 40M_ch) changes from busy to idle, and therefore the system switches over to transmission on 20M_ch_a and carries out 20 M channel transmission.

Furthermore, when considering at least the carrier sensing state on the 20 M_ch_b side after 20M_ch_a has continued to be idle for the AIFS time+random backoff time through carrier sensing of only 20M_ch_a in S202 and 203 of FIG. 6, it is also possible to assume not only the carrier sensing state at that time point but also the fact that the 20M_ch_b side has continued to be idle for a certain time (e.g., the AIFS time or DIFS (Distributed Inter Frame Space) period) (second specific period) as a condition for judging that the 40 M channel transmission is possible.

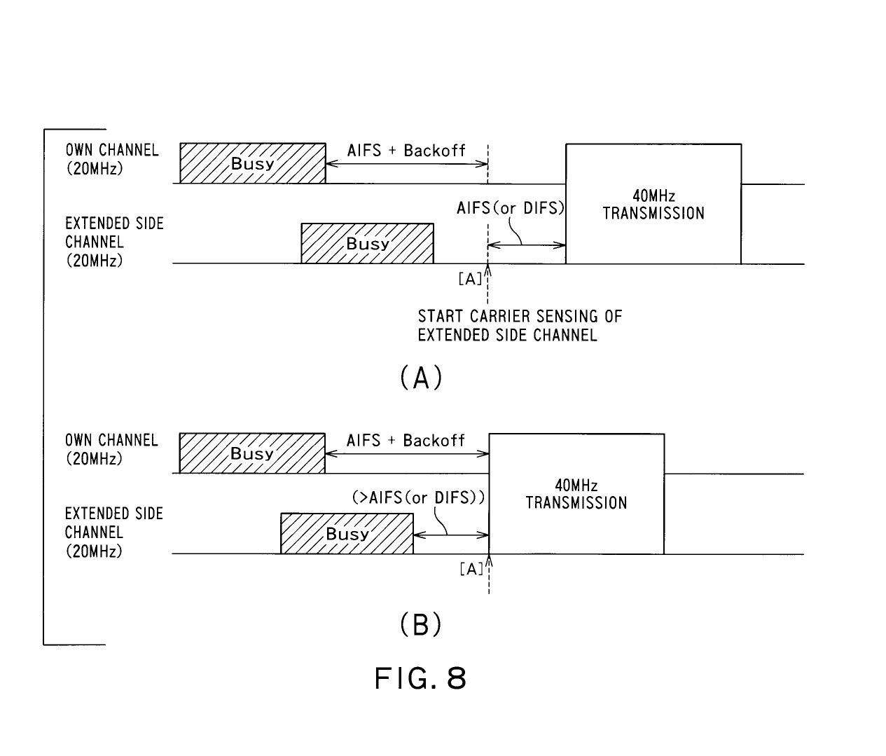

For example, as shown in FIG. 8(A), when at least the carrier sensing state of 20 M_ch_b continues to be idle for a certain period from a time point ([A]) at which 20M_ch_a has continued to be idle for the AIFS time+random backoff time, the system judges that 40 M channel transmission is possible and carries out 40 M channel transmission.

Furthermore, as shown in FIG. 8(B), when the carrier sensing state of at least 20 M_ch_b has already continued to be idle for a certain period at a time point ([A]) at which 20M_ch_a has continued to be idle for the AIFS time+random backoff time, the system judges that the 40 M channel transmission is possible and carries out 40 M channel transmission.

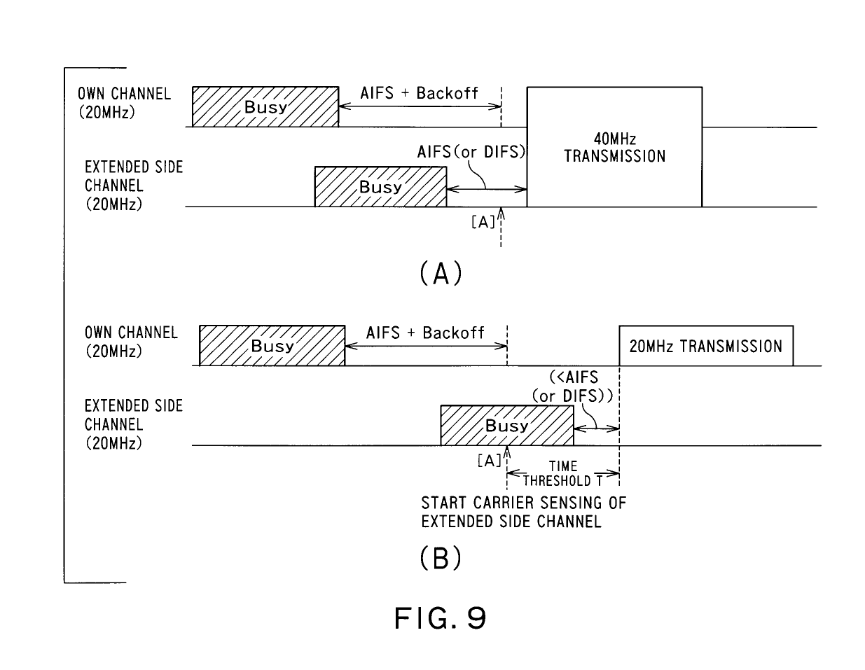

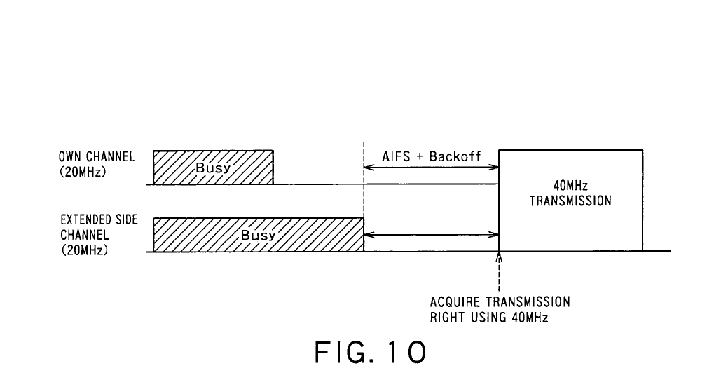

Furthermore, as shown in FIG. 9(A), when an idle state including the case of a busy state has not continued for a certain period at a time point ([A]) at which 20M_ch_a has continued to be idle for the AIFS time+random backoff time, the system judges that the 40 M channel transmission is possible at a time point at which the idle state has continued for a certain period and carries out 40 M channel transmission.

Furthermore, as shown in FIG. 9(B), when an idle state has not continued for a certain period within the time threshold T from the time point [A] at which 20M_ch_a has continued to be idle for the AIFS time+random backoff time, the system switches over to transmission on 20M_ch_a and carries out 20 M channel transmission.

When considering the carrier sensing state of 20M_ch_b in FIG. 8(A), FIG. 8(B), FIG. 9(A) and FIG. 9(B), it is possible to make a judgment only based on the carrier sensing state of 20M_ch_b or making a judgment based on the carrier sensing state on 40M_ch including 20M_ch_a to prevent packet collision on 20M_ch_a. Furthermore, it is also possible to consider a method of resuming carrier sensing of only 20M_ch_a at a time point at which the system ascertains that 20M_ch_a has become busy again while the carrier sensing state of at least 20 M_ch_b continues to be idle for a certain period.

In this way, at a time point at which 20M_ch_a has continued to be idle for the AIFS time+random backoff time, even if the carrier sensing state of 20M_ch_b is busy (case where the system judges 40 M channel transmission based on at least the instantaneous carrier sensing state of 20 M_ch_b) or if the idle state has not continued for a certain period (case where the system judges 40 M channel transmission based on at least the idle state of 20 M_ch_b for a certain period), the second embodiment attempts to carry out 40 M channel transmission until the time threshold T until which an improvement of throughput using the 40 M channel transmission can be expected without immediately switching from the 40 M channel transmission to the 20 M channel transmission, and therefore an improvement of throughput using the 40 M channel transmission can be expected.

In this sense, there is a slight difference in the implication of the time threshold T between the first embodiment and the second embodiment. While the first embodiment conversely sets the time threshold T to prevent throughput degradation by attempting to carry out 40 M channel transmission, the second embodiment sets the time threshold T to make the most of the throughput improvement effect using the 40 M channel transmission.

Here, the time threshold T in the second embodiment is basically determined by a policy similar to that of the first embodiment. In such a case, the transmission time that can be shortened by the 40 M channel transmission or the allowable transmission delay time, whichever is the shorter, is assumed to be a maximum time of the time threshold T and a value resulting from multiplying the maximum time by α (<1) which has been determined according to the busy rate of 20M_ch_a within a range assuming the maximum time as an upper limit may be set as the time threshold T. Furthermore, when considering the carrier sensing state on the 20M_ch_b side, not only because the higher the busy rate of 20M_ch_a, the higher is the possibility that it will take time to acquire the transmission right (when carrier sensing is performed for whole 40M_ch) but also because the probability of packet collision increases (carrier sensing is performed with only 20M_ch_b without considering the carrier sensing state of 20M_ch_a), it is possible to consider a method of deciding α such that α decreases as the busy rate increases.

Furthermore, by setting α (<1) which is determined according to the busy rate of 20M_ch_a, the amount of transmission time that can be shortened using the 40 M channel transmission or the allowable delay time of the data to be transmitted to zero, if the carrier sensing state of 20M_ch_b is busy or the idle state has not continued for a certain period at a time point at which 20M_ch_a has continued to be idle for the AIFS time+random backoff time, it is possible to immediately switch over to 20 M channel transmission. That is, by setting α to zero when, for example, the busy rate of 20M_ch_a is equal to or above a certain value, it is also possible to immediately switch over to 20 M channel transmission when 20M_ch_b is busy or the idle state has not continued for a certain period.

What is claimed is:

1. A radio communication apparatus comprising:
a first communication unit configured to carry out radio communication using any one of two first channels having identical bandwidths;
a second communication unit configured to carry out radio communication using a second channel including both bands of the two first channels;
a carrier sensing state manager configured to manage carrier sensing states of at least one of the first channels and the second channel;
a determining unit configured to determine whether to transmit transmission data using the first channel or the second channel;
a transmission right acquiring unit configured to attempt to acquire a transmission right using the second channel based on the carrier sensing state of the second channel when the transmission data is determined to be transmitted using the second channel; and
a controller configured to perform control such that the transmission data is transmitted using any one of the first channels when a time during which an attempt to acquire the transmission right using the second channel is made exceeds a time threshold set in advance.

2. The apparatus according to claim 1, wherein the time threshold is equal to or below a time resulting from subtracting a transmission time required when the transmission data is transmitted using the second channel from a transmission time required when the transmission data is transmitted using the first channel.

3. The apparatus according to claim 1, wherein the time threshold is equal to or below a time resulting from subtracting a transmission time required when the transmission data is transmitted using the second channel from a transmission time required when the transmission data is transmitted using the first channel or an delay bound time of the transmission data given beforehand, whichever is the shorter.

4. The apparatus according to claim 2, further comprising a time threshold setting unit configured to set the time threshold,
wherein the time threshold setting unit increases the time threshold as the time resulting from subtracting the transmission time required when the transmission data is transmitted using the second channel from the transmission time required when the transmission data is transmitted using the first channel increases.

5. The apparatus according to claim 2, further comprising:
a time threshold setting unit configured to set the time threshold; and
an acquisition unit configured to acquire a usage rate of any one of the first channels,
wherein the time threshold setting unit decreases the time threshold as the usage rate of any one of the first channels increases.

6. The apparatus according to claim 5, wherein the acquisition unit calculates a rate at which the first channel is busy from the carrier sensing state of any one of the first channels as the usage rate of the first channel.

7. The apparatus according to claim 3, further comprising a time threshold setting unit configured to set the time threshold,
wherein the time threshold setting unit increases the time threshold as the amount of delay bound time of the transmission data given beforehand increases.

8. The apparatus according to claim 1, wherein the transmission right acquiring unit acquires the transmission right of the second channel when the second channel continues to be idle for a certain specific period.

9. The apparatus according to claim 8, wherein the certain specific period is a fixed period specified beforehand or a period resulting from adding a period determined by a pseudo random number to the fixed period.

10. The apparatus according to claim 1, wherein the transmission right acquiring unit acquires the transmission right when
one of the two first channels satisfies a condition that the one continues to be idle for a first specific period and
at least the other first channel becomes idle at and after a time point at which the condition is satisfied.

11. The apparatus according to claim 1, wherein the transmission right acquiring unit acquires the transmission right when one of the two first channels satisfies a condition that the one continues to be idle for a first specific period and when tracking back to the past from a time point at which the condition is satisfied, the other first channel continues to be idle for a second specific period.

12. The apparatus according to claim 1, wherein the transmission right acquiring unit acquires the transmission right
when one of the two first channels satisfies a first condition that the one continues to be idle for a first specific period, and
when the other first channel satisfies a second condition that the other continues to be idle for a second specific period, at any time point at or after a time point at which the first condition is satisfied.

13. The apparatus according to claim 10, wherein the first specific period is a fixed period specified beforehand or a period resulting from adding a period determined by a pseudo random number to the fixed period.

14. The apparatus according to claim 11, wherein the second specific period is a fixed period specified beforehand.

15. The apparatus according to claim 10, wherein the controller counts a lapse of time during which an attempt to acquire the transmission right using the second channel is made from the time point at which the condition is satisfied.

16. A radio communication method comprising:
managing carrier sensing states of any one of two first channels having identical bandwidths and a second channel including both bands of the two first channels;
determining whether to transmit transmission data using the first channel or the second channel;
attempting to acquire a transmission right using the second channel based on the carrier sensing state of the second channel when the transmission data is determined to be transmitted using the second channel; and
performing control such that the transmission data is transmitted using any one of the first channels when the time during which the attempt to acquire the transmission right using the second channel is made exceeds a time threshold set in advance.

17. The method according to claim 16, wherein the time threshold is equal to or below a time resulting from subtracting a transmission time required when the transmission data is transmitted using the second channel from a transmission time required when the transmission data is transmitted using the first channel.

18. The method according to claim 16, wherein the preset time threshold is equal to or below a time resulting from subtracting the transmission time required when the transmission data is transmitted using the second channel from the transmission time required when the transmission data is transmitted using the first channel or an delay bound time of the transmission data given beforehand, whichever is the shorter.
